(19) United States
(12) Patent Application Publication
(10) Pub. No.: US 2023/0298407 A1
(43) Pub. Date: Sep. 21, 2023

(54) CONTROL SYSTEM, CONTROL METHOD OF CONTROL SYSTEM, ELECTRONIC DEVICE, AND RECORDING MEDIUM

(71) Applicant: HONDA MOTOR CO., LTD., Tokyo (JP)

(72) Inventors: Tatsuroh Saitoh, Tokyo (JP); Takumi Nomura, Tokyo (JP)

(21) Appl. No.: 18/167,239

(22) Filed: Feb. 10, 2023

(30) Foreign Application Priority Data
Mar. 16, 2022 (JP) 2022-041126
Aug. 30, 2022 (JP) 2022-136834

(51) Int. Cl. G07C 5/00

(52) U.S. Cl. CPC G07C 5/008

(57) ABSTRACT

A control system includes a first electronic device, a second electronic device for receiving vehicle data related to the vehicle from the first electronic device, a communication device for transmitting the vehicle data received by the second electronic device to an external device of the vehicle, a determination unit for determining whether or not to transmit the vehicle data to the external device, and an imparting unit for imparting time data to the vehicle data to be transmitted to the external device in the case where the determination unit determines to transmit the vehicle data to the external device.

### INCORPORATION BY REFERENCE

The present application claims priority under 35 U.S.C.§ 119 to Japanese Patent Application No. 2022-041126 filed on Mar. 16, 2022 and Japanese Patent Application No. 2022-136834 filed on Aug. 30, 2022. The content of the application is incorporated herein by reference in its entirety.

### BACKGROUND OF THE INVENTION

### Field of the Invention

The present invention relates to a control system, a control method of a control system, an electronic device, and a recording medium.

### Description of the Related Art

In recent years, efforts have intensified to provide access to a sustainable transportation system that considers people in a vulnerable position from among traffic participants. Towards this realization, research and development has been focused on further improving traffic safety and convenience. Also, technology for transmitting vehicle data related to a vehicle to an external device is conventionally known as a technology for further improving traffic safety and convenience (for example, Japanese Patent Laid-Open No. 2021-138210). Japanese Patent Laid-Open No. 2021-138210 discloses technology in which a data collection device mounted in a vehicle transmits CAN data, which uses vehicle information related to the vehicle, to a vehicle data management device.

### SUMMARY OF THE INVENTION

Incidentally, since restrictions may not occur in the utilization of vehicle data in an external device of a vehicle, it is desirable for time data to be imparted to the vehicle data. However, if this is a configuration in which time data is imparted to all traffic data, there will be a problem in which a communication traffic amount in the vehicle increases.

Accordingly, the present invention has an objective in which easily utilized vehicle data can be transmitted to an external device of a vehicle, while suppressing an increase in a communication traffic amount in the vehicle.

One aspect of the present invention is a control system of a vehicle that includes a first electronic device, a second electronic device for receiving vehicle data related to the vehicle from the first electronic device, a communication device for transmitting the vehicle data received by the second electronic device to an external device of the vehicle, a determination unit for determining whether or not to transmit the vehicle data to the external device, and an imparting unit for imparting time data to the vehicle data to be transmitted to the external device in the case where the determination unit determines to transmit the vehicle data to the external device.

According to the aspect of the present invention, easily utilized vehicle data can be transmitted to an external device of a vehicle, while suppressing an increase in a communication traffic amount in the vehicle.

### BRIEF DESCRIPTION OF THE DRAWINGS

FIG. 1 is a figure showing a control system of a vehicle;

FIG. 2 is a block diagram showing the main components of a control system;

FIG. 3 is a figure showing a data structure of packing data;

FIG. 4 is a flowchart showing operations of a central ECU and a connection ECU;

FIG. 5 is a flowchart showing operations of a central ECU;

FIG. 6 is a block diagram showing the main components of a control system;

FIG. 7 is a flowchart showing operations of a central ECU; and

FIG. 8 is a flowchart showing operations of a central ECU.

### DETAILED DESCRIPTION OF THE PREFERRED EMBODIMENTS

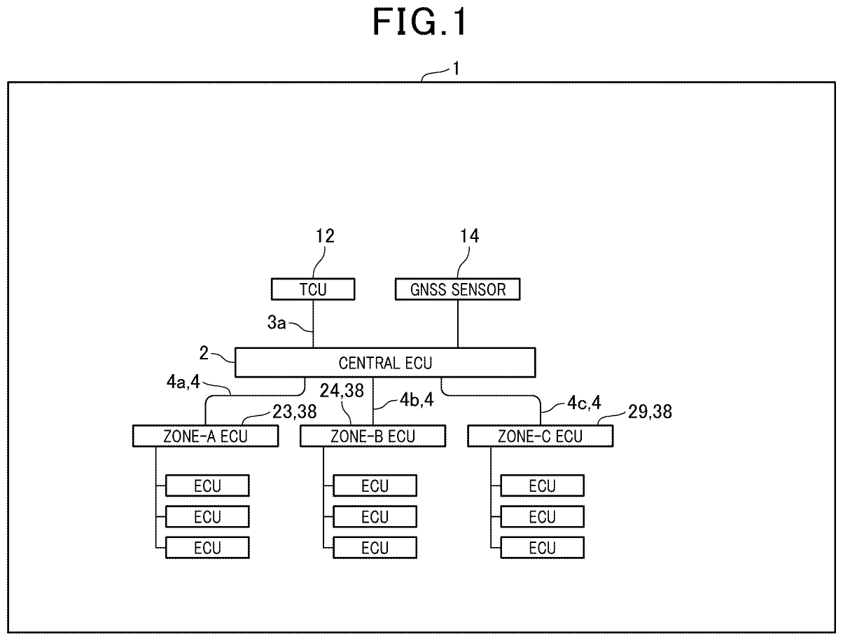

FIG. 1 is a view showing a control system 1 of a vehicle.

The control system 1 includes a central ECU 2 for performing general control and information processes of the vehicle. The central ECU 2 is connected to a communication line, which includes a first communication line 3a and second communication lines 4a, 4b, 4c. The central ECU 2 implements a function of a gateway for managing the reception of communication data between these communication lines. Moreover, the central ECU 2 executes Over-The-Air (OTA) management. OTA management includes a control related to a process for downloading an update program of a vehicle device, which is included in the vehicle, from a server outside the vehicle, and the OTA management includes a control related to a process for applying the downloaded update program to the vehicle device.

The first communication line 3a and the second communication lines 4a, 4b, 4c are configured of a bus for performing standards-based communication of CAN or Ethernet (R) standards, or the first communication line 3a and the second communication lines 4a, 4b, 4c are configured of communication lines for performing Peer-to-Peer (P2P) communication. Note that, the second communication lines 4a, 4b, 4c may be configured of a plurality of communication lines for performing the same standards-based communication, or the second communication lines 4a, 4b, 4c may be configured of a plurality of communication lines for performing different types of standards-based communication.

A Telematics Control Unit (TCU) 12 is connected to the first communication line 3a. The TCU 12 is a wireless communication device in compliance with the communication standards of mobile communication systems. ECUs are connected to the central ECU 2. An ICB, a rear camera, a speaker, a microphone, a meter panel, a steering SW, the TCU 12, a Vehicle-to-Everything (V2X) communication device, a GNSS sensor 14, and a touch panel are provided, as examples, as the ECUs connected to the central ECU 2. The V2X communication device perform vehicle-to-vehicle communication or road-to-vehicle communication. The touch panel includes a display 16 and a touch sensor 17.

The ICB is an In-Vehicle Infotainment (IVI)-ECU. The ICB provides various types of information and entertainment to passengers of the vehicle, by using the speaker, the microphone, the GNSS sensor 14, the touch panel and the like.

A zone-A ECU 23 is connected to the second communication line 4a. A plurality of ECUs is connected to the zone-A ECU 23.

A zone-B ECU 24 is connected to the second communication line 4b. A plurality of ECUs is connected to the zone-B ECU 24. A driving device, a battery, a steering controller, and a Vehicle-Stability-Assist (VSA) device are provided, as examples, as the ECUs connected to the zone-B ECU 24. A brake, an accelerator, an Electric Power Steering (EPS) and the like may be included in the steering controller. The driving device, for example, is a motor or an internal combustion engine for driving the vehicle.

A zone-C ECU 29 is connected to the second communication line 4c. A plurality of ECUs is connected to the zone-C ECU 29. A lamp body and a window motor are provided, as examples, as the ECUs connected to the zone-C ECU 29. The lamp body, for example, includes a head lamp, a tail lamp, a turn signal and the like. The window motor opens and closes a vehicle window. Moreover, a door sensor, a door lock mechanism, an Electronic Steering Lock (ESL), and an air conditioner are provided, as examples, as the ECUs connected to the zone-C ECU 29. The door sensor senses an operation of a vehicle door. The door lock mechanism performs locking or unlocking of a door of the vehicle. An LF/RF antenna for performing wireless communication with an electronic key of the vehicle is provided, as an example, as the ECUs connected to the zone-C ECU 29. The electronic key is an electronic device having a wireless communication function, and is called a smart key or a FOB key.

The zone-A ECU 23, the zone-B ECU 24, and the zone-C ECU 29 are ECUs connected to the central ECU 2. Accordingly, in the following explanation, in the case where the zone-A ECU 23, the zone-B ECU 24, and the zone-C ECU 29 are not distinguished, the reference numeral of “38” will be attached as a “connection ECU”.

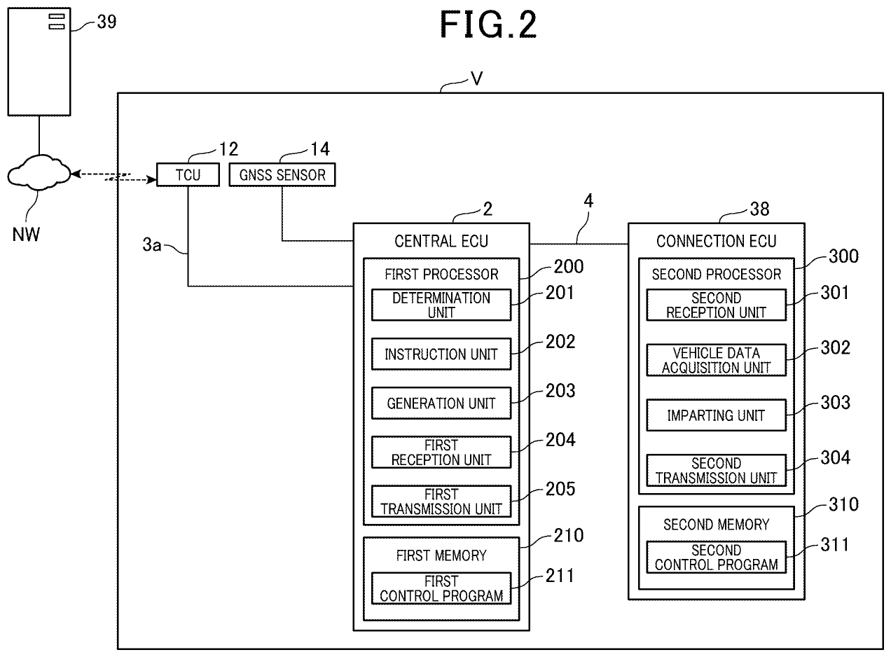

FIG. 2 is a block diagram showing the main components of the control system 1.

The first communication line 3a and the TCU 12 are connected to the central ECU 2. Moreover, the GNSS sensor 14 is connected to the central ECU 2. Moreover, the connection ECU 38 is connected, via the second communication line 4, to the central ECU 2. Note that, the second communication line 4 is an expression that does not distinguish the second communication lines 4a, 4b, and 4c. The communication standards of the first communication line 3a exemplify Ethernet standards. Moreover, the communication standards of the second communication line 4 exemplify CAN standards. Note that, the first communication line 3a has a communication band that is wider than the communication band of the second communication line 4.

The central ECU 2 corresponds to a “second electronic device” of the present disclosure. The connection ECU 38 corresponds to a “first electronic device” of the present disclosure. The TCU 12 corresponds to a “communication device” (transmitter/receiver, circuit) of the present disclosure. The GNSS sensor 14 corresponds to an “output device” of the present disclosure.

The TCU 12 communicates with the external device 39, which is connected to a communication network NW. The external device 39 is a server device (computer) that sets a vehicle V, for example, as a client. The communication network NW is configured of a public line network, a dedicated line, or another communication circuit. The TCU 12 transmits packing data PD, which is generated by the central ECU 2, to the external device 39. A detailed description of the packing data PD will be described later.

The GNSS sensor 14 transmits time data TD, which shows the present time acquired from a GNSS satellite, to the central ECU 2 and the connection ECU 38. The GNSS sensor 14 periodically (for example, every second) transmits the time data TD.

The connection ECU 38 includes a second processor 300 such as a Central processing Unit (CPU) or a Micro Processor Unit (MPU), a second memory 310, and an interface circuit to which equipment such as devices or sensors are connected.

The second memory 310 is a storage device for storing, in a non-volatile manner, programs or data executed by the second processor 300. The second memory 310 is configured of a magnetic storage device, a semiconductor memory element such as a flash Read Only Memory (ROM), or another type of non-volatile storage device. Moreover, the second memory 310 may include a Random Access memory (RAM) that constitutes a working area of the second processor 300. Moreover, the first memory 210 may include a non-volatile storage device such as a Hard Disk Drive (HDD) or a Solid State Drive (SSD). The second memory 310 stores data processed by the second processor 300, or the second memory 310 stores a second control program 311 executed by the second processor 300.

The second processor 300 functions as a second reception unit 301, a vehicle data acquisition unit 302, an imparting unit 303, and a second transmission unit 304, by having the second processor 300 read and execute the second control program 311 stored by the second memory 310.

The second reception unit 301 corresponds to a “reception unit” of the present disclosure.

The second reception unit 301 receives the time data TD from the GNSS sensor 14, via the central ECU 2. Moreover, the second reception unit 301 receives instruction information, which will be described later, from the central ECU 2.

The vehicle data acquisition unit 302 acquires vehicle data VD related to the vehicle V having the control system 1. The type of vehicle data VD acquired by the vehicle data acquisition unit 302 differs in accordance with the connection ECU 38. For example, the vehicle data acquisition unit 302 of the zone-C ECU 29 acquires, from each of the devices connected to the zone-C ECU 29, vehicle data VD showing the operation states of the devices.

The imparting unit 303 imparts the time data TD, which is received by the second reception unit 301, to the vehicle data VD acquired by the vehicle data acquisition unit 302.

Specifically, the imparting unit 303 generates a vehicle data frame F1, in which the vehicle data VD acquired by the vehicle data acquisition unit 302 has been recorded. The vehicle data frame F1 is a frame compliant to CAN communication standards. Moreover, the imparting unit 303 generates a time data frame F2, in which the time data TD received by the second reception unit 301 has been recorded. The time data frame F2 is a frame compliant to CAN communication standards. The imparting unit 303 links the generated time data frame F2 with the generated vehicle data frame F1. According to this linking process, the imparting unit 303 imparts the time data TD received by the second reception unit 301 to the vehicle data VD acquired by the vehicle data acquisition unit 302.

The second transmission unit 304 transmits the vehicle data VD, to which the time data TD has been imparted by the imparting unit 303, to the central ECU 2.

Specifically, the second transmission unit 304 transmits the vehicle data frame F1, to which the time data frame F2 is linked, to the central ECU 2.

The central ECU 2 includes a first processor 200 such as a CPU or an MPU, a first memory 210, and an interface circuit to which equipment such as devices or sensors are connected.

The first memory 210 is a storage device for storing, in a non-volatile manner, programs or data executed by the first processor 200. The first memory 210 is configured of a magnetic storage device, a semiconductor memory element such as a flash ROM, or another type of non-volatile storage device. Moreover, the first memory 210 may include a RAM that constitutes a working area of the first processor 200. Moreover, the first memory 210 may include a non-volatile storage device such as an HDD or an SSD. The first memory 210 stores data processed by the first processor 200, or the first memory 210 stores a first control program 211 executed by the first processor 200.

The first processor 200 functions as a determination unit 201, an instruction unit 202, a generation unit 203, a first reception unit 204, and a first transmission unit 205, by having the first processor 200 read and execute the first control program 211 stored by the first memory 210.

The determination unit 201 determines whether or not to transmit the vehicle data VD to the external device 39. In the case where there is a transmission request of the vehicle data VD from the external device 39 to the vehicle V, the determination unit 201 determines to impart the time data TD to the vehicle data VD.

In the case where the determination unit 201 determines to transmit the vehicle data VD to the external device 39, the instruction unit 202 performs an instruction, to the connection ECU 38, for imparting the time data TD to the vehicle data VD. Specifically, in the case where the determination unit 201 determines to transmit the vehicle data VD to the external device 39, the instruction unit 202 transmits instruction information to the connection ECU 38. The instruction information is information for instructing the matter of imparting the time data TD to the vehicle data VD.

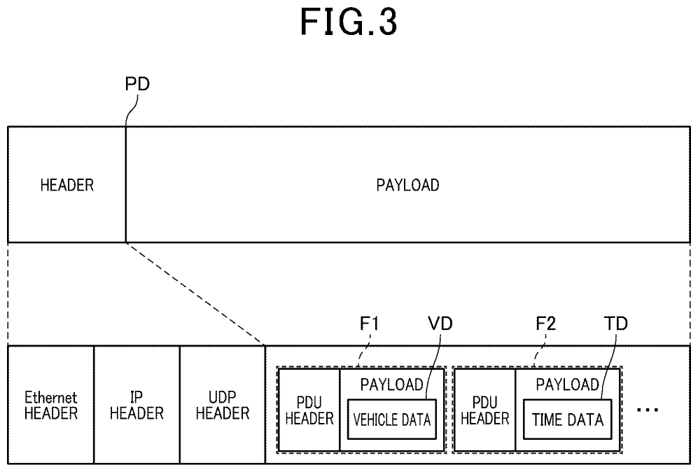

The generation unit 203 generates packing data PD. The packing data PD is data for packing one or a plurality of the vehicle data VD and the time data TD. A detailed description of the packing data PD will be described, by referring to FIG. 3.

FIG. 3 is a figure showing a data structure of the packing data PD.

The packing data PD of the present embodiment has an Ethernet standards-based header and payload. The header of the packing data PD includes an Ethernet header, an IP header, and a UDP header. One or a plurality of combinations of the vehicle data frame F1 and the time data frame F2 are recorded in the payload of the packing data PD.

The vehicle data frame F1 has a Protocol Data Unit (PDU) header, and a payload in which the vehicle data VD has been recorded. The time data frame F2 has a PDU header, and a payload in which the time data TD has been recorded.

Note that, the vehicle data frame F1 and the time data frame F2 are linked by a value recorded in the PDU header.

The generation unit 203 generates the packing data PD, by recording the vehicle data frame F1, to which the time data frame F2 is linked, to the payload of the packing data PD. Note that, in the present embodiment, a frame to be recorded in the packing data PD by the generation unit 203 is a frame received from the connection ECU 38 by the first reception unit 204.

The first reception unit 204 receives the time data TD from the GNSS sensor 14. The first reception unit 204 receives the combination of the vehicle data frame F1 and the time data frame F2 from the connection ECU 38.

The first transmission unit 205 transmits the packing data PD generated by the generation unit 203 to the TCU 12. The TCU 12 transmits the packing data PD received from the central ECU 2 to the external device 39. The first transmission unit 205 transmits the time data TD received by the first reception unit 204 to the connection ECU 38.

Next, the operations of each of the units of the control system 1 will be described.

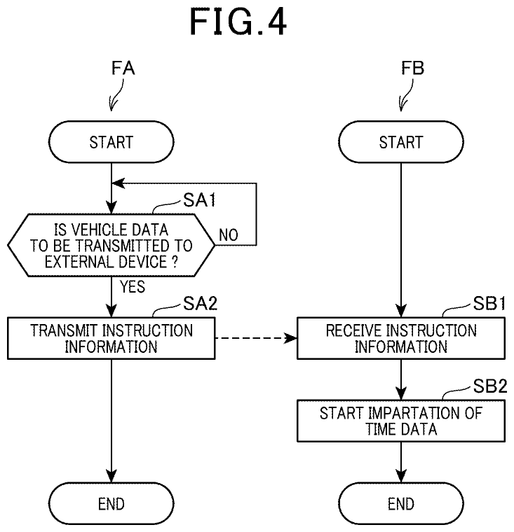

FIG. 4 is a flowchart showing the operations of the central ECU 2 and the connection ECU 38.

In FIG. 4, flowchart FA shows the operations of the central ECU 2, and flowchart FB shows the operations of the connection ECU 38.

As shown in flowchart FA, the determination unit 201 determines whether or not to transmit the vehicle data VD to the external device 39 (step SA1). In the case where the determination unit 201 determines not to transmit the vehicle data VD to the external device 39 (step SA1: NO), the determination unit 201 again performs the determination of step SA1.

On the other hand, in the case where the determination unit 201 determines to transmit the vehicle data VD to the external device 39 (step SA1: YES), the instruction unit 202 transmits instruction information to the connection ECU 38 (step SA2).

As shown in flowchart FB, the second reception unit 301 receives the instruction information from the connection ECU 38 (step SB1).

To continue, the imparting unit 303 starts impartation of the time data TD to the vehicle data VD (step SB2).

From step SB2 onwards, the connection ECU 38 transmits the vehicle data VD, to which the time data TD has been imparted by the imparting unit 303, to the central ECU 2, each time the vehicle data acquisition unit 302 acquires the vehicle data VD.

Next, the operations of the central ECU 2, in relation to the packing data PD after impartation of the time data TD has started, will be described.

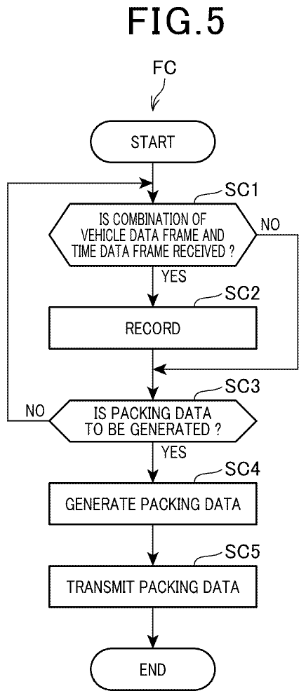

FIG. 5 is a flowchart FC showing the operations of the central ECU 2.

The first reception unit 204 determines whether or not to receive the combination of the vehicle data frame F1 and the time data frame F2 from the connection ECU 38 (step SC1). Namely, the first reception unit 204 determines whether or not to receive the vehicle data VD, to which the time data TD has been imparted by the imparting unit 303, from the connection ECU 38, in step SC1.

In the case where the first reception unit 204 determines not to receive the combination of the vehicle data frame F1 and the time data frame F2 (step SC1: NO), the first processor 200 performs the process of step SC3.

On the other hand, in the case where the first reception unit 204 determines to receive the combination of the vehicle data frame F1 and the time data frame F2 (step SC1: YES), the first reception unit 204 records the received combination to the first memory 210 (step SC2). Next, the generation unit 203 determines whether or not to generate the packing data PD (step SC3). For example, in the case where the first reception unit 204 receives a predetermined number of the vehicle data VD, the generation unit 203 determines to generate the packing data PD.

In the case where the generation unit 203 determines not to generate the packing data PD (step SC2: NO), the first processor 200 returns the process to step SC1.

On the other hand, in the case where the generation unit 203 determines to generate the packing data PD (step SC3: YES), the generation unit 203 generates the packing data PD (step SC4). One or a plurality of combinations of the vehicle data frame F1 and the time data frame F2 recorded in step SC2 are included in the payload of the packing data PD generated in step SC4.

Next, the first transmission unit 205 transmits the packing data PD generated by the generation unit 203 to the TCU 12 (step SC5).

As described above, the time data TD is packed in the packing data PD. In this way, by having the time data TD included in packing data PD, in the case where events (failure detection of the connection ECU 38, operation state detection of a driver, usage frequency/usage time of content used by an ICB, variations in vehicle position or vehicle speed and the like), which are generated by each connection ECU 38 connected to the central ECU 2, are set as the vehicle data VD, data of these events can be set to more easily utilized data.

Next, a second embodiment will be described.

For the components of the second embodiment, the same reference numerals are attached to the same components as the first embodiment, and a detailed description of these components will be omitted.

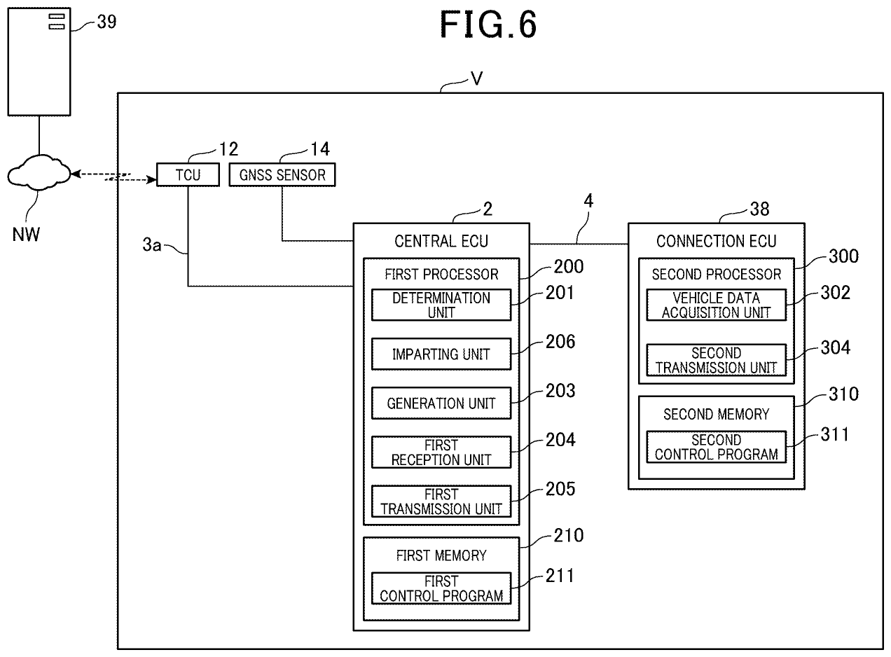

FIG. 6 is a block diagram showing the main components of the control system 1 of the second embodiment.

The central ECU 2 in the present embodiment corresponds to a “second electronic device” and an “electronic device” of the present disclosure. The first processor 200 in the present embodiment corresponds to a “processor” of the present disclosure. The first control program 211 in the present embodiment corresponds to a “program” of the present disclosure. The first memory 210 in the present embodiment corresponds to a “storage unit” of the present disclosure.

The GNSS sensor 14 of the present embodiment outputs the time data TD to the central ECU 2.

The second processor 300 of the present embodiment functions as a vehicle data acquisition unit 302 and a second transmission unit 304, by having the second processor 300 read and execute the second control program 311. Namely, the second processor 300 of the present embodiment does not function as a second reception unit 301 and an imparting unit 303.

The second transmission unit 304 of the present embodiment transmits the vehicle data VD acquired by the vehicle data acquisition unit 302 to the central ECU 2.

Specifically, the second transmission unit 304 generates the vehicle data frame F1, in which the vehicle data VD acquired by the vehicle data acquisition unit 302 has been recorded, and the second transmission unit 304 transmits the generated vehicle data frame F1 to the central ECU 2.

The first processor 200 of the present embodiment functions as a determination unit 201, an imparting unit 206, a generation unit 203, a first reception unit 204, and a first transmission unit 205, by having the first processor 200 read and execute the first control program 211 stored in the first memory 210.

The imparting unit 206 receives the vehicle data VD from the connection ECU 38, and the imparting unit 206 imparts the time data TD, which is received by the first reception unit 204, to the received vehicle data VD.

Specifically, the imparting unit 206 generates the time data frame F2, in which time data TD received by the first reception unit 204 has been recorded, and the imparting unit 206 links the generated time data frame F2 to the vehicle data frame F1 received from the connection ECU 38.

When the imparting unit 206 links the time data frame F2 to the vehicle data frame F1, the imparting unit 206 records the vehicle data frame F1, to which the time data frame F2 is linked, to the first memory 210.

The generation unit 203 of the present embodiment generates the packing data PD, by recording the vehicle data frame F1, to which the time data frame F2 is linked, to the payload of the packing data PD. Note that, a frame to be recorded in the packing data PD by the generation unit 203 of the present embodiment is a frame linked by the imparting unit 206.

The first reception unit 204 of the present embodiment receives the time data TD from the GNSS sensor 14. Moreover, the first reception unit 204 of the present embodiment receives the vehicle data frame F1 from the connection ECU 38.

Next, the operations of each of the units of the control system 1 in the second embodiment will be described.

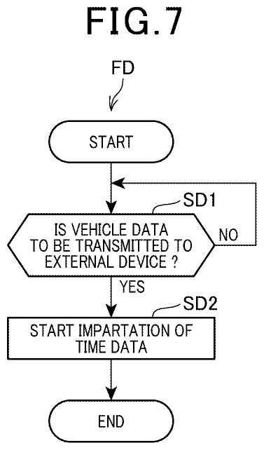

FIG. 7 is a flowchart FD showing the operations of the central ECU 2.

As shown by flowchart FA, the determination unit 201 determines whether or not to transmit the vehicle data VD to the external device 39 (step SD1). In the case where the determination unit 201 determines not to transmit the vehicle data VD to the external device 39 (step SD1: NO), the determination unit 201 again performs the determination of step SD1.

On the other hand, in the case where the determination unit 201 determines to transmit the vehicle data VD to the external device 39 (step SD1: YES), the imparting unit 206 starts impartation of the time data TD to vehicle data VD (step SD2).

From step SD2 onwards, the central ECU 2 imparts the time data TD to the vehicle data VD received from the connection ECU 38. Namely, from step SD2 onwards, the central ECU 2 links the time data frame F2 to the vehicle data frame F1 received from the connection ECU 38.

Next, the operations of the central ECU 2, related to the packing data PD after impartation of the time data TD has started, will be described.

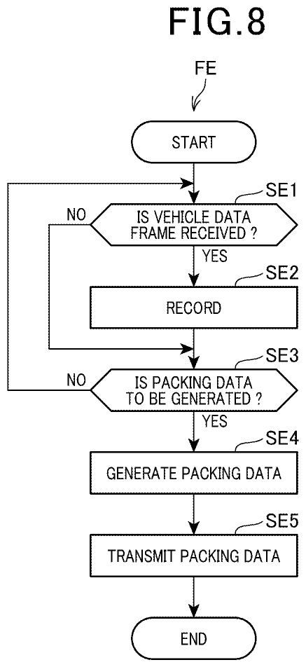

FIG. 8 is a flowchart FE showing the operations of the central ECU 2.

As shown by flowchart FD, the first reception unit 204 determines whether or not the vehicle data frame F1 is received from the connection ECU 38 (step SE1). Namely, the first reception unit 204 determines whether or not the vehicle data VD is received from the connection ECU 38, in step SE1.

In the case where the first reception unit 204 determines that the vehicle data frame F1 is not received from the connection ECU 38 (step SE1: NO), the first reception unit 204 again performs the determination of step SE3.

On the other hand, in the case where the first reception unit 204 determines that the vehicle data frame F1 is received from the connection ECU 38 (step SE3: YES), the imparting unit 206 links the vehicle data frame F1 received from the connection ECU 38 and the time data frame F2, in which the time data TD, which shows the time when the vehicle data frame F1 is received, has been recorded, and records the linked frames in the first memory 210 (step SE2).

Next, the generation unit 203 determines whether or not to generate the packing data PD (step SE3). In the case where the generation unit 203 determines not to generate the packing data PD (step SE3: NO), the first processor 200 returns the process to step SE1.

On the other hand, in the case where the generation unit 203 determines to generate the packing data PD (step SE3: YES), the generation unit 203 generates the packing data PD (step SE4). In step SE4, the generation unit 203 generates the packing data PD, in which the combination of the vehicle data frame F1 and the time data frame F2, which has been recorded in the first memory 210 until positively determined in step SE3, has been recorded.

Next, the first transmission unit 205 transmits the packing data PD generated by the generation unit 203 to the TCU 12 (step SE5).

In each of the described embodiments, only one aspect is shown, and this aspect can be arbitrarily modified or applied.

Each of the described embodiment has a configuration in which the vehicle data frame F1 and the time data frame F2 are included in one packing data PD. Another embodiment may have a configuration in which two types of packing data PD, which are packing data PD that includes only the vehicle data frame F1 and packing data PD that includes only the time data frame F2, are generated, and these two types of packing data PD are continuously transmitted to the external device 39.

The first embodiment has a configuration in which the connection ECU 38 imparts the time data TD to the vehicle data VD, in the case where the instruction unit 202 instructs this impartation to the connection ECU 38. In the case of this configuration, there may be cases where the instruction unit 202 imparts the time data TD to the connection ECU 38, after the connection ECU 38 transmits the vehicle data VD to the central ECU 2.

Accordingly, in another embodiment, the imparting unit 303, in this case, imparts first time data TD, which corresponds to first vehicle data VD transmitted to the central ECU 2, to second vehicle data VD transmitted to the central ECU 2 after the first vehicle data VD. Also, the second transmission unit 304 transmits second vehicle data VD, which is imparted by the first time data TD, to the central ECU 2. In the case where there is vehicle data VD that is transmitted after the second vehicle data VD, the connection ECU 38 transmits N vehicle data VD to the central ECU 2, by imparting N−1 time data TD, which corresponds to N−1 vehicle data VD, to the N vehicle data VD. Here, N is an integer of 3 or more.

According to this embodiment, in the case where the connection ECU 38 transmits the vehicle data VD to the central ECU 2, without imparting the time data TD, the connection ECU 38 can transmit the time data TD, which corresponds to the transmitted vehicle data VD, to the central ECU 2. Accordingly, in the case where the connection ECU 38 transmits the vehicle data VD to the central ECU 2, without imparting the time data TD, the central ECU 2 can receive the time data TD, which corresponds to the already received vehicle data VD. Accordingly, even in the case where the connection ECU 38 transmits the vehicle data VD to the central ECU 2, without imparting the time data TD, the control system 1 can transmit easily utilized data to the external device 39.

Each of the described embodiments has a configuration in which the central ECU 2 generates the packing data PD. However, the packing data PD may be generated by the TCU 12. In the case of this configuration, the central ECU 2 and the TCU 12 perform CAN standards-based communication. Moreover, in a first embodiment of this configuration, the central ECU 2 transmits the vehicle data frame F1 and the time data frame F2, which are received from the connection ECU 38, to the TCU 12. Moreover, in a second embodiment of this configuration, the central ECU 2 transmits the vehicle data frame F1 and the time data frame F2 to the TCU 12. In a second embodiment of this configuration, the central ECU 2 may be configured to impart the time data TD, which shows the time when the central ECU 2 transmits the vehicle data frame F1, to the vehicle data VD. As a result of this, it is not necessary to store the time data TD in the first memory 210, and unnecessarily using the storage region of the first memory 210 can be avoided.

In another embodiment, the type of the vehicle data VD transmitted to the external device 39 can be specified by the external device 39. In the case of this configuration, the control system 1 imparts the time data TD to the vehicle data VD specified by the external device 39, and the control system 1 transmits the vehicle data VD of the type specified by the external device 39 to the external device 39.

Each of the described embodiments exemplifies the GNSS sensor 14 as an “output device” of the present disclosure. However, in another embodiment, an “output device” of the present disclosure may be a device other than the GNSS sensor 14. A device with a built-in crystal resonator is provided, as an example, as a device other than the GNSS sensor 14.

The first processor 200 and the second processor 300 may be configured of a plurality of processors, or the first processor 200 and the second processor 300 may be configured of a single processor. These processors may be hardware programed so as to implement function units of the described processor. In this case, for example, these processors are configured of an Application Specific Integrated Circuit (ASIC) or a Field Programmable Gate Array (FPGA).

Moreover, each unit of the control system 1 shown in FIG. 1 is an example, and the specific embodiment is not particularly limited. Namely, it is not necessary for hardware individually corresponding to each unit to be implemented, and it is needless to say that it is possible to implement the functions of each unit by having one processor execute a program. Moreover, in the described embodiment, one part of the functions implemented by software may be implemented by hardware, or one part of the functions implemented by hardware may be implemented by software. Other than this, the specific detailed configuration of each of the other units of the control system 1 can be arbitrarily changed in a range not deviating from the gist of the present invention.

Moreover, the step units of the operations shown in FIGS. 4, 5, 7, and 8 are divided in accordance with the main process content, and the present invention is not limited by the division means and names of the process units. The step units may be divided into step units of a greater number, in accordance with the process content. Moreover, the step units may be divided so that one step unit includes a greater number of processes. Moreover, the order of the steps may be appropriately changed in a range that does not impede the gist of the present invention.

The first control program 211 can be implemented in a state where the first control program 211 is recorded on a portable information recording medium. While a semiconductor storage device such as a magnetic recording medium such as a hard disk, an optical recording medium such as a CD, a Universal Serial Bus (USB) memory, or a Solid State Drive (SSD) are provided, as examples, as the information recording medium, other recording mediums can be used. The second control program 311 can be implemented in a state where the second control program 311 is recorded on a portable information recording medium, similar to the first control program 211.

The embodiments support the following configurations.

### (Configuration 1)

A control system of a vehicle that includes a first electronic device, a second electronic device for receiving vehicle data related to the vehicle from the first electronic device, a communication device for transmitting the vehicle data received by the second electronic device to an external device of the vehicle, a determination unit for determining whether or not to transmit the vehicle data to the external device, and an imparting unit for imparting time data to the vehicle data to be transmitted to the external device in the case where the determination unit determines to transmit the vehicle data to the external device.

According to the control system of Configuration 1, since time data is not imparted to all of the vehicle data, vehicle data that is easily utilized by the external device of the vehicle can be transmitted to the external device of the vehicle, while suppressing an increase in communication traffic in the vehicle.

### (Configuration 2)

The control system of Configuration 1 further includes an output device for periodically outputting the time data, wherein the first electronic device comprises a reception unit for receiving the time data from the output device, and the imparting unit, and the imparting unit imparts the time data received by the reception unit to the vehicle data.

According to the control system of Configuration 2, since the imparting unit imparts time data that is periodically output by the output device, it is not necessary for the first electronic device to perform a process for requesting time data to the output device. Accordingly, the processing load relating to an impartation of time data can be reduced, and an increase in communication traffic in the vehicle can be suppressed.

### (Configuration 3)

The control system of Configuration 2, wherein the second electronic device includes the determination unit, and an instruction unit for instructing impartation of the time data to the first electronic device in the case where the determination unit determines to transmit the vehicle data to the external device, and the imparting unit imparts the time data to the vehicle data in the case where the imparting unit is instructed by the instruction unit.

According to the control system of Configuration 3, since the first electronic device imparts time data in the case where there is an instruction from the second electronic device, an increase in a communication traffic amount in the vehicle can be suppressed.

### (Configuration 4)

The control system of Configuration 3, wherein in the case where the first vehicle data is transmitted to the second electronic device, and thereafter there is an instruction, in the first electronic device from the instruction unit, for imparting the first time data corresponding to the first vehicle data, the imparting unit imparts the first time data to the second vehicle data to be transmitted to the second electronic device after the first vehicle data.

According to the control system of Configuration 4, the second electronic device can receive time data corresponding to already received vehicle data, even in the case where the first electronic device transmits vehicle data to the second electronic device without imparting time data. Accordingly, the control system can transmit data that is easily utilized by the external device to the external device, even in the case where the first electronic device transmits vehicle data to the second electronic device without imparting time data.

### (Configuration 5)

The control system of Configuration 1, wherein the second electronic device includes the determination unit and the imparting unit.

According to the control system of Configuration 5, easily utilized vehicle data can be transmitted to the external device of the vehicle, while suppressing an increase in communication traffic in the vehicle, by a process of the second electronic device.

### (Configuration 6)

The control system of Configuration 5, wherein the second electronic device includes a storage unit for storing the time data showing a time when the vehicle data is received from the first electronic device, and the imparting unit imparts the time data stored in the storage unit to the vehicle data.

According to the control system of Configuration 6, vehicle data to which appropriate time data is imparted can be transmitted to the external device, even at a timing when the timing the vehicle data is received and the timing the vehicle data is transmitted to the external device are separated, by storing the time data.

### (Configuration 7)

The control system of Configuration 5, wherein the imparting unit imparts the time data when transmitting the vehicle data to the communication device.

According to the control system of Configuration 7, time data can be imparted to the vehicle data, while avoiding unnecessary use of the storage region of the second electronic device.

### (Configuration 8)

The control system of any one of Configurations 5 to 7, wherein a first communication line for communication between the second electronic device and the communication device has a communication band wider than a communication band of a second communication line for communication between the first electronic device and the second communication device.

According to the control system of Configuration 8, while the communication traffic amount increases by an impartation of time data, the communication band between the first electronic device and the communication device is wider than the communication band between the first electronic device and the second communication device. Therefore, causing an effect on communication of the vehicle can be suppressed.

### (Configuration 9)

A control method of a control system that includes a first electronic device, a second electronic device for receiving vehicle data related to a vehicle from the first electronic device, and a communication device for transmitting the vehicle data received by the second electronic device to an external device of the vehicle, the control method includes determining whether or not to transmit the vehicle data to the external device, and imparting time data to the vehicle data to be transmitted to the external device in the case where determining to transmit the vehicle data to the external device.

According to the control method of a control system of Configuration 9, an effect the same as the effect for the control system of Configuration 1 is accomplished.

### (Configuration 10)

An electronic device of a vehicle communicating with an external device that includes a determination unit for determining whether or not to transmit vehicle data related to the vehicle to the external device, and an imparting unit for imparting time data to the vehicle data to be transmitted to the external device in the case where the determination unit determines to transmit the vehicle data to the external device.

According to the electronic device of Configuration 10, an effect the same as the effect for the control system of Configuration 1 is accomplished.

### (Configuration 11)

A non-transitory computer-readable recording medium recording a program for causing a processer of an electronic device of a vehicle communicating with an external device to function as a determination unit for determining whether or not to transmit vehicle data related to the vehicle to the external device, and an imparting unit for imparting time data to the vehicle data to be transmitted to the external device in the case where the determination unit determines to transmit the vehicle data to the external device.

According to the recording medium of Configuration 11, an effect the same as the effect for the control system of Configuration 1 is accomplished.

### REFERENCE SIGNS LIST

1 Control System
2 Central ECU (Second Electronic Device, Electronic
Device)
3a First Communication Line
4 Second Communication Line
4a Second Communication Line
4b Second Communication Line
4c Second Communication Line
12 TCU (Communication Device)
14 GNSS Sensor (Output Device)
23 Zone-A ECU (First Electronic Device)
24 Zone-B ECU (First Electronic Device)
29 Zone-C ECU (First Electronic Device)
38 Connection ECU (First Electronic Device)
39 External Device
200 First Processor (Processor)
201 Determination Unit
202 Instruction Unit
203 Generation Unit
204 First Reception Unit
205 First Transmission Unit
206 Imparting Unit
210 First memory (Storage Unit)
211 First Control Program (Program)
300 Second Processor
301 Second Reception Unit
302 Vehicle Data Acquisition Unit
303 Imparting Unit
304 Second Transmission Unit
310 Second memory
311 Second Control Program
TD Time Data
V Vehicle
VD Vehicle Data

What is claimed is:

1. A control system of a vehicle, comprising:
a first electronic device;
a second electronic device for receiving vehicle data related to the vehicle from the first electronic device;
a communication device for transmitting the vehicle data received by the second electronic device to an external device of the vehicle;
a determination unit for determining whether or not to transmit the vehicle data to the external device; and
an imparting unit for imparting time data to the vehicle data to be transmitted to the external device in the case where the determination unit determines to transmit the vehicle data to the external device.

2. The control system according to claim 1, further comprising:
an output device for periodically outputting the time data, wherein
the first electronic device comprises a reception unit for receiving the time data from the output device, and the imparting unit, and
the imparting unit imparts the time data received by the reception unit to the vehicle data.

3. The control system according to claim 2, wherein
the second electronic device comprises the determination unit, and an instruction unit for instructing impartation of the time data to the first electronic device in the case where the determination unit determines to transmit the vehicle data to the external device, and
the imparting unit imparts the time data to the vehicle data in the case where the imparting unit is instructed by the instruction unit.

4. The control system according to claim 3, wherein
in the case where the first vehicle data is transmitted to the second electronic device, and thereafter there is an instruction, in the first electronic device from the instruction unit, for imparting first time data corresponding to the first vehicle data, the imparting unit imparts the first time data to the second vehicle data to be transmitted to the second electronic device after the first vehicle data.

5. The control system according to claim 1, wherein
the second electronic device comprises the determination unit and the imparting unit.

6. The control system according to claim 5, wherein
the second electronic device comprises a storage unit for storing the time data showing a time when the vehicle data is received from the first electronic device, and
the imparting unit imparts the time data stored in the storage unit to the vehicle data.

7. The control system according to claim 5, wherein
the imparting unit imparts the time data when transmitting the vehicle data to the communication device.

8. The control system according to claim 5, wherein
a first communication line for communication between the second electronic device and the communication device has a communication band wider than a communication band of a second communication line for communication between the first electronic device and the second communication device.

9. A control method of a control system of a vehicle comprising: a first electronic device; a second electronic device for receiving vehicle data related to a vehicle from the first electronic device; and a communication device for transmitting the vehicle data received by the second electronic device to an external device of the vehicle, the control method comprising:
determining whether or not to transmit the vehicle data to the external device; and
imparting time data to the vehicle data to be transmitted to the external device in the case where determining to transmit the vehicle data to the external device.

10. An electronic device of a vehicle communicating with an external device, comprising:
a determination unit for determining whether or not to transmit vehicle data related to the vehicle to the external device; and
an imparting unit for imparting time data to the vehicle data to be transmitted to the external device in the case where the determination unit determines to transmit the vehicle data to the external device.

11. A non-transitory computer-readable recording medium recording a program for causing a processer of an electronic device of a vehicle communicating with an external device to function as:
a determination unit for determining whether or not to transmit vehicle data related to the vehicle to the external device; and
an imparting unit for imparting time data to the vehicle data to be transmitted to the external device in the case where the determination unit determines to transmit the vehicle data to the external device.
